(19) United States
(12) Patent Application Publication
(10) Pub. No.: US 2003/0132378 A1
(43) Pub. Date: Jul. 17, 2003

(54) Electronic methods of correcting the electric field of quadrupole mass filters to improve performance

(76) Inventors: Donald Matthew Burns, Halifax (GB); Stephen Taylor, Liverpool (GB); John Raymond Gibson, Liverpool (GB)

Correspondence Address: Hoffman, Wasson & Gitler, P.C., Suite 522, 2361 Jefferson Davis Highway, Arlington, VA, 22202, US

(21) Appl. No.: 10/322,757

(22) Filed: Dec. 19, 2002

(30) Foreign Application Priority Data
Jan. 3, 2002 (GB) 0200026.3

(51) Int. Cl. H01J 49/42

(52) U.S. Cl. 250/282; 250/292

(57) ABSTRACT

A method for improving performance of a quadrupole mass filter by correcting the electric field of the quadrupole mass filter by using electronic adjustment mechanisms to balance an electric field thereby correcting imbalances in the electric field caused by mechanical asymmetries or contamination of the electrode surfaces.

### BACKGROUND OF THE INVENTION

A quadrupole mass filter (QMF) consists of four electrode rods held in a square parallel array, usually supported by ceramic discs or collars. Opposite electrode rods are connected together as shown in FIG. 1 and these are in turn connected to a combined AC and DC power supply. In application, ions are ejected from an ion source device; they travel through the QMF, and are detected upon their exit from the QMF. The QMF only transmits ions of a specified mass, this mass being selected by the magnitude of the applied AC and DC voltages.

Experimental evidence has shown that imbalances in the electric field, possibly due to mechanical asymmetry or contamination of the electrode surface, are detrimental to QMF performance.

### SUMMARY OF THE INVENTION

A method of correcting imbalances in the electric field in quadrupole mass filters possibly caused by mechanical asymmetries or contamination of electrode surfaces is corrected by using a potentiometer and or power supply variations to the rods.

### BRIEF DESCRIPTION OF THE DRAWINGS

FIG. 1 is a conventional quadrupole mass filter and its power supply;

FIG. 2 is a first preferred embodiment of the invention;

FIG. 3 is a second preferred embodiment of the invention; and

FIG. 4 is a preferred embodiment of the invention with individual control of the voltages applied to all electrode rods.

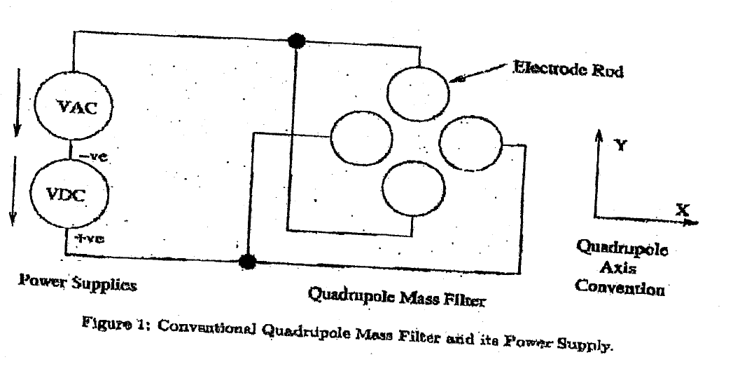

### DISCLOSURE OF THE INVENTION

Disclosed is an electronic solution to the electrical imbalances and the above-described asymmetries based on supplying individual electrode rods from separate power supplies. FIG. 2 shows a first embodiment, where a potentiometer is used to balance the electric field of the QMF in the y-axis. This method has been experimentally tested and is capable of correcting mechanical asymmetries.

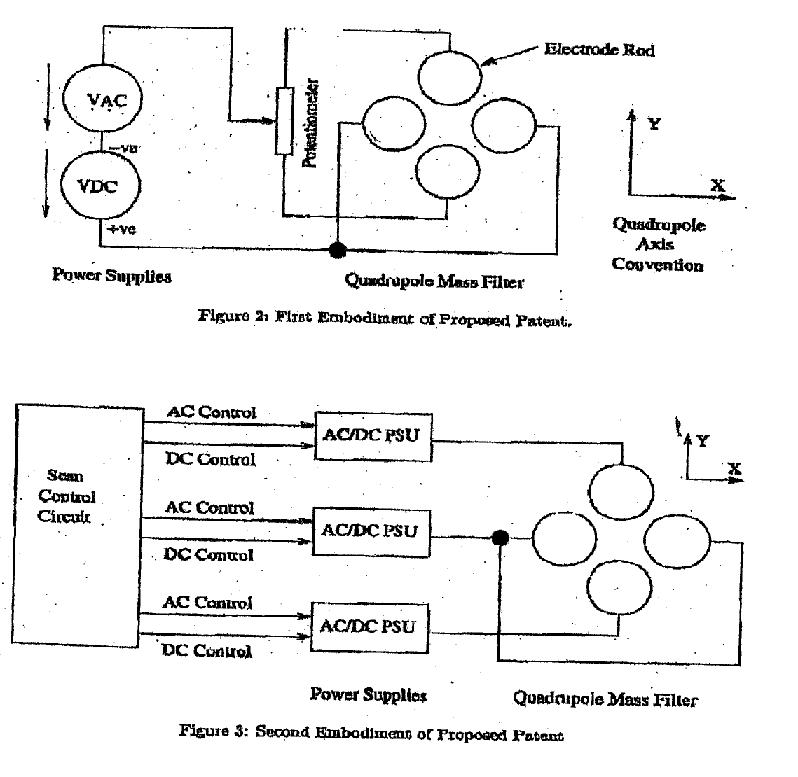

FIG. 3 details a second preferred embodiment. In this situation, the x-axis electrode rods are excited by a common power supply. Separate power supplies individually excite the y-axis electrode rods. The function of the scan control circuit is two fold. First, it provides ramping control signals to the power supplies to facilitate mass scanning as in a normal quadrupole mass spectrometer. Additionally, it allows individual adjustment of both the AC and DC supplies to the individual y-axis electrode rods, thereby permitting adjustment of the y-axis electric field for both its AC and DC components.

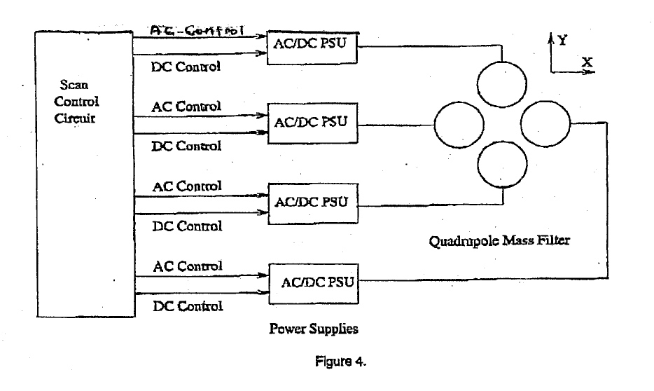

The embodiments described by FIGS. 2 and 3 can include adjustment mechanisms for the x-axis electrode rods, resulting in two additional embodiments of the invention. FIG. 4 details the additional mechanism for the preferred embodiment detailed in FIG. 3.

Throughout the invention there is no reference to the additional DC voltage that can be applied to all rods in order to attract the ions into the QMF. This voltage can be positive or negative depending on the charge of the ions and is referred to as the pole bias or ion energy. Pole bias or ion energy, not shown in the figures, is assumed implemented as part of every power supply.

The four embodiments described are merely exemplary of methods for achieving electrical field symmetry. Other methodology that utilizes imbalanced excitation for adjustment of the electric field symmetry of a QMF is also contemplated as part of this invention.

What is claimed is:

1. A method for improving performance of a quadrupole mass filter by correcting the electric field of the quadrupole mass filter, comprising:
supplying power separately to electrode rods of the quadrupole mass filter and
using at least one potentiometer to balance an electric field in a y-axis thereby correcting imbalances in the electric field caused by mechanical asymmetries or contamination of the electrode surfaces.

2. The method of claim 1, wherein at least one x-axis electrode rod is excited by at least one common power supply and wherein at least one y-axis electrode rod is excited by separate power supplies to act as a scan control circuit to provide ramping control signals to the power supply to facilitate mass scanning and allow individual adjustment of AC and DC power supplies to the electrode rods, thereby permitting adjustment of the electric field.

3. The method as claimed in claim 1, wherein at least one adjustment mechanism is provided for the x-axis electrode rods to assist in preventing imbalances in the electric field.
